(19) United States
(12) Patent Application Publication
(10) Pub. No.: US 2003/0235729 A1
(43) Pub. Date: Dec. 25, 2003

(54) Protection device for a fuel cell system

(75) Inventor: Gerhard Konrad, Ulm (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/456,089

(22) Filed: Jun. 6, 2003

(30) Foreign Application Priority Data
Jun. 21, 2002 (DE) 102 27 754.0

(51) Int. Cl. H01M 8/04

(52) U.S. Cl. 429/22

(57) ABSTRACT

A protection device for a fuel cell system includes a gas sensor and an oxygen supply device. The fuel cell system includes a membrane module and a downstream fuel cell. The membrane module includes a hydrogen-selective membrane for separating hydrogen as a permeate gas from hydrogen-containing reformate gas. The downstream fuel cell includes an anode circuit for the permeate gas. The gas sensor monitors the oxygen content or the carbon dioxide content in the permeate gas. The oxygen supply device meters oxygen to the anode circuit as a function of an output signal of the gas sensor.

Priority is claimed to German patent application 102 27 754.0, filed Jun. 21, 2002, and the subject matter of which is hereby incorporated by reference herein.

The present invention relates to a protection device for a fuel cell system, which contains a membrane module including a hydrogen-selective membrane for separating hydrogen as a permeate gas from hydrogen-containing reformate gas and a downstream fuel cell including an anode circuit for the permeate gas, and a method of operating the fuel cell system.

### BACKGROUND

It is possible to operate fuel cell systems by using pure hydrogen, as well as a reformate, i.e., hydrogen-rich gas which is extracted by reforming hydrocarbons or hydrocarbon derivatives. In this case, as a rule, the fuel cell must be supplied with more hydrogen than would be required based upon the stoichiometry. In pure hydrogen systems, the excess hydrogen, which amounts to approximately 20% to 50%, is recirculated. In systems operating on reformate, the excess gas, for example, is fed to a catalytic burner and is used for covering the heat requirements in the reformer. If this is not possible or not sensible due to the reformer technology applied, recirculation is also used here.

During operation of fuel cell systems using reformate, even traces of carbon monoxide result in an efficiency loss, and higher concentrations result in poisoning, i.e., the irreversible damage of the fuel cell, since carbon monoxide accumulates in the precious metal catalysts used in the fuel cell, blocking same.

In order to prevent catalyst poisoning by carbon monoxide, which, in reformate operation is always present in the anode gas, even if only in traces, a small amount of air (1%-3%) is added to the gas prior to introducing it into the anode part of the fuel cell, as is described in U.S. Pat. No. 6,210,820 for example. If the excess gas is recirculated, the concentration of nitrogen as an inert component inevitably increases, causing the partial pressure of hydrogen to steadily drop. In order to prevent an efficiency loss of the fuel cell, anode gas must thus be discharged in regular time intervals so that no gradual poisoning, and no efficiency loss of the fuel cell associated with it, occurs. Since the amount of hydrogen present in the anode gas discharged is no longer available for power generation, the efficiency of the entire system decreases correspondingly.

A fuel cell system in which the inert gas problem is solved by using pure oxygen instead of air is described in German Patent Application 19 646 354, the oxygen being obtained by electrolysis and fed into the fuel supply line.

International Publication WO 02/20300 describes a fuel cell system which is automatically stopped when the carbon monoxide content exceeds a critical value.

The above-mentioned publications relate to fuel cell systems in which a hydrogen-rich gas is generated, via reforming from hydrocarbon or a hydrocarbon derivative, in a chemical process, and purified of residual carbon monoxide prior to being fed to the fuel cell. The technological complexity with regard to devices and controllers for the metered addition of air or oxygen is substantial, mainly due to the necessary carbon monoxide sensors.

If the hydrogen is physically separated, i.e., by using a membrane module containing one or several hydrogen-selective membranes, the problems described above do not exist during normal operation since the hydrogen, diffused by the membranes, is extremely pure. However, in the case of a defect, such as the sudden failure of a membrane due to cracking, for example, a sudden rise in the carbon monoxide concentration in the anode circuit may occur. In this case, a non-negligible amount of reformate flows into the anode circuit, unpurified and consequently having a high carbon monoxide concentration. An irreversible poisoning of the catalysts in the fuel cell may result. However, a fuel cell having an upstream reformer may not be turned off immediately, since the reformer is still hot. Therefore, the controlled shutdown of the entire system may take a certain amount of time during which the fuel cell itself should stay in operation if possible, in order to convert the hydrogen still being produced into electrical power, both in order to utilize the hydrogen and not to release unconverted hydrogen into the environment.

### SUMMARY OF THE INVENTION

The present invention provides a protection device for a fuel cell system which contains a membrane module including a hydrogen-selective membrane for separating hydrogen as a permeate gas from hydrogen-containing reformate gas and a downstream fuel cell including an anode circuit for the permeate gas. The protection device includes a gas sensor for monitoring the oxygen content and the carbon dioxide content in the permeate gas, and by a device for metered oxygen addition to the anode circuit as a function of the output signal of the gas sensor.

The present invention also provides a method of operating a fuel cell system. According to the method, by reforming hydrocarbon or hydrocarbon derivatives, hydrogen-rich gas is obtained from which hydrogen is separated as a permeate gas using a membrane module and is recirculated through the anode part of a fuel cell. Oxygen is metered into the anode circuit in an amount which only minimally affects the efficiency of the fuel cell system, the oxygen content and the carbon dioxide content in the permeate gas being continuously monitored. In case of an abnormal drop in the oxygen content or an increase in the carbon dioxide content, a shutdown procedure of the fuel cell system is triggered, the amount of oxygen in the anode circuit being increased during the shutdown procedure.

Although not necessary during normal operation, a constantly low oxygen concentration of approximately 1 wt. % is set in the anode circuit. The simplest way to establish this concentration is to feed a precalculated amount of oxygen into the anode circuit during the manufacture or maintenance of the fuel cell system. This amount of oxygen remains there during operation.

The oxygen concentration in the anode circuit is monitored in one embodiment with an oxygen sensor. If a defect or a leakage occurs at the membrane module, so that amounts of carbon monoxide that are harmful to the catalyst of the fuel cell reach the fuel cell, the oxygen concentration drops due to the reaction 2CO+O₂→2CO₂ which is confirmed by the oxygen sensor. If a drop in the oxygen concentration is detected, a controlled shutdown of the fuel cell system and its components is initiated. The shutdown procedure takes a few minutes since some system components, such as the reformer, for example, which is operated at relatively high temperatures, cannot be shut down instantly. In order to intensify the decomposition of carbon monoxide, additional oxygen is simultaneously fed into the anode circuit from an oxygen source, preferably an electrolyzer or a pressure cartridge. This bridges the time required for the shutdown. This emergency shutdown procedure relates only to the time period between the occurrence of a leakage and the complete shutdown of the entire fuel cell system and prevents irreversible damage to the catalyst layers in the fuel cell due to unusually high carbon monoxide concentrations.

During the emergency shutdown procedure, air may simply be fed into the anode circuit instead of pure oxygen, since, for the emergency shutdown, the inert gas problem is irrelevant due to the increase in nitrogen concentration. The lower efficiency of the fuel cell system at higher oxygen concentrations is also irrelevant for the emergency shutdown.

In the case where the preset oxygen concentration in the anode circuit does not remain constant during normal operation, e.g., due to a very small membrane leakage, the slow drop of the oxygen concentration is detected by the oxygen sensor, whereupon, during operation, additional oxygen may be metered into the anode circuit via a check valve until the oxygen concentration measured by the oxygen sensor again reaches the value desired for normal operation. This makes it possible to continuously operate the fuel cell system in spite of the small membrane leakage. Pure oxygen is advantageous for the additional metering described; however, air may be used instead if a portion of the anode gas is regularly discharged.

Instead of an oxygen sensor, a carbon dioxide sensor with which the non-existence of carbon dioxide is monitored is used in an alternative embodiment; in the case of evidence of carbon dioxide, which, in the case of a leakage, was created by the reaction 2CO+O₂→2CO₂, the shutdown procedure described above including air or oxygen supply is executed.

Well-tested and frequently used sensors may be utilized as oxygen sensors or carbon dioxide sensors, e.g., lambda probes, which are suitable for operation in a motor vehicle, unlike the known measuring methods for carbon monoxide which are very expensive and unsuitable for use in motor vehicles.

If the oxygen for the fuel cell is supplied via electrolysis, the electrolysis may be carried out by using the electrical power generated by the fuel cell system and the water also generated in the system and reclaimed from the exhaust gas flows.

Due to the small oxygen requirement for the present invention, a pressurized oxygen cartridge, which may be changed if the need arises, may alternatively be used as an oxygen source.

The present invention not only enables a safe emergency shutdown with a limited-time continued operation of the fuel cell without it being irreversibly damaged, but also, during normal operation, a gradual poisoning of the fuel cell by traces of carbon monoxide due to smallest membrane leakages may be prevented by occasional or permanent metered additions of small amounts of oxygen.

A separation unit may be additionally provided in the anode circuit which separates and removes from the circuit the carbon dioxide formed by the reaction of carbon monoxide with oxygen, so that the system is also able to handle larger leakages without having to execute an emergency shutdown.

### BRIEF DESCRIPTION OF THE DRAWING

The present invention is elaborated upon below based on exemplary embodiments with reference to the drawing, in which:

FIG. 1 shows a fuel cell system including a membrane module, a downstream fuel cell, and a device for protection against catalyst poisoning.

### DETAILED DESCRIPTION

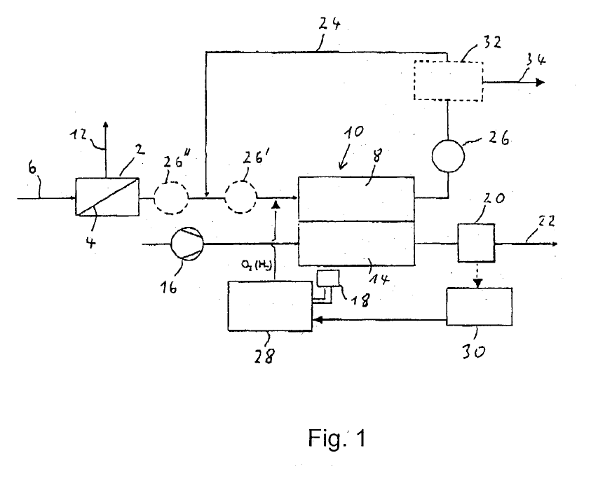

FIG. 1 shows a fuel cell system that includes a membrane module 2 which contains a schematically depicted hydrogen-selective membrane 4. Membrane module 2 receives hydrogen-containing reformate gas 6 from a gas generating system (not shown), known as a reformer. Hydrogen from reformate gas 6, diffused through membrane 4 in membrane module 2, is fed as permeate gas to anode part 8 of a fuel cell 10. The hydrogen-depleted gas, not diffused through membrane 4, is discharged from membrane module 2 in the form of raffinate or residual gas 12.

Air is fed to a cathode part 14 of fuel cell 10 via a compressor 16. Hydrogen from membrane module 2 and oxygen from the air of compressor 16 react with one another in fuel cell 10 to generate electrical power, which is collected in an accumulator 18, for example. The gas outlet of cathode part 14 is connected to a water separator 20 in which the water, formed during the reaction in fuel cell 10, is separated from exhaust air 22.

Hydrogen, having passed through anode part 8 of fuel cell 10 without reacting with oxygen, is again fed to the inlet of anode part 8 in a circuit 24. An oxygen sensor 26 for monitoring the oxygen content in circuit 24 is situated in the line that connects the outlet and the inlet of anode part 8 to close circuit 24.

Prior to startup of the fuel cell system, an oxygen concentration of approximately 0.1 to 1 wt. % is set in circuit 24, for example, by feeding an appropriate amount of oxygen into circuit 24, either one time or in regular intervals.

The oxygen concentration in the circuit is constantly monitored by oxygen sensor 26 during operation of the fuel cell system, and in the case of an abnormal drop in the oxygen content due to carbon monoxide which has reached circuit 24, a programmed shutdown procedure of the fuel cell system is triggered. Additional oxygen is fed into circuit 24 during the shutdown procedure in order to substantially increase the oxygen concentration measured by oxygen sensor 26, thus preventing poisoning of fuel cell 10 by carbon monoxide.

In the exemplary embodiment shown, the additional oxygen is obtained in an electrolyzer 28 which generates oxygen and hydrogen via electrolysis, namely by using electrical power from accumulator 18 or directly from the fuel cell from water which, in the exemplary embodiment, has been separated by water separator 20 and stored in a container 30. The oxygen generated in electrolyzer 28 may, for example, be fed into circuit 24 upstream from anode part 8, as indicated in the figure by an arrow. The hydrogen generated in electrolyzer 28 may also be fed into circuit 24.

In place of electrolyzer 28, a pressurized oxygen cartridge may be used as an oxygen source.

Circuit 24 may contain a separating unit 32 for carbon dioxide 34. It is indifferent whether oxygen sensor 26 is situated between the outlet of anode part 8 of fuel cell 10 and separating unit 32, as depicted in the figure, or directly upstream from the permeate gas inlet of anode part 8, as depicted with reference number 26′.

Instead of oxygen sensor 26, a carbon dioxide sensor may alternatively be used to monitor the non-existence of carbon dioxide in circuit 24. Such a carbon dioxide sensor may also be situated upstream from circuit 24, as depicted with reference number 26″.

If an oxygen sensor 26, 26′ is used, it may be used not only for monitoring the oxygen concentration in circuit 24 for an emergency shutdown of the fuel cell system, but also for a controlled feed of oxygen from electrolyzer 28 or a different source, or of air, into circuit 24 using a check valve in order to set or maintain the low oxygen content of approximately 0.1 to 1 wt %, either because the prevailing oxygen in the circuit is consumed over time for the decomposition of small amounts of carbon monoxide, which has passed through membrane module 2, or because the preset oxygen concentration in circuit 24 does not remain stable enough for other reasons.

What is claimed is:

1. A protection device for a fuel cell system, the fuel cell system including a membrane module and a downstream fuel cell, the membrane module including a hydrogen-selective membrane for separating hydrogen as a permeate gas from hydrogen-containing reformate gas, the downstream fuel cell including an anode circuit for the permeate gas, the protection device comprising:
a gas sensor configured to monitor at least one of an oxygen content and a carbon dioxide content in the permeate gas; and
an oxygen supply device configured to add oxygen in a metered fashion to the anode circuit as a function of an output signal of the gas sensor.

2. The protection device as recited in claim 1 wherein the gas sensor is connected in the anode circuit upstream of an anode part of the fuel cell.

3. The protection device as recited in claim 1 wherein the gas sensor is connected in the anode circuit downstream of an anode part of the fuel cell.

4. The protection device as recited in claim 1 wherein the gas sensor includes a carbon dioxide sensor connected upstream of the anode circuit.

5. The protection device as recited in claim 1 wherein the gas sensor includes a lambda probe configured to measure the oxygen content.

6. The protection device as recited in claim 1 wherein the oxygen supply device is configured to add air so as to add the oxygen.

7. The protection device as recited in claim 1 wherein the oxygen supply device is configured to add the oxygen as substantially pure oxygen from an oxygen source.

8. The protection device as recited in claim 7 wherein the oxygen source includes at least one of an electrolyzer and a pressurized cartridge.

9. The protection device as recited in claim 1 wherein the anode circuit includes a separating unit for carbon dioxide.

10. A motor vehicle fuel cell system having a protection device comprising
a membrane module, the membrane module including a hydrogen-selective membrane for separating hydrogen as a permeate gas from hydrogen-containing reformate gas;
a fuel cell downstream of the membrane module, the fuel cell including an anode circuit for the permeate gas;
a gas sensor configured to monitor at least one of an oxygen content and a carbon dioxide content in the permeate gas; and
an oxygen supply device configured to add oxygen in a metered fashion to the anode circuit as a function of an output signal of the gas sensor.

11. A method of operating a fuel cell system, comprising:
reforming hydrocarbon or hydrocarbon derivatives so as to obtain hydrogen-rich gas;
separating hydrogen from the hydrogen-rich gas as a permeate gas using a membrane module;
recirculating the permeate gas through an anode part of a fuel cell using an anode circuit;
metering oxygen into the anode circuit in an amount which minimally affects an efficiency of the fuel cell system;
continuously monitoring at least one of an oxygen content and a carbon dioxide content in the permeate gas;
triggering a shutdown procedure of the fuel cell system upon an abnormal drop in the oxygen content or an increase in the carbon dioxide content; and
increasing the amount of oxygen in the anode circuit during the shutdown procedure.

12. The method as recited in claim 11 wherein the continuously monitoring includes measuring the at least one of the oxygen content and the carbon dioxide content of the permeate gas in the anode circuit.

13. The method as recited in claim 11 wherein the continuously monitoring includes measuring the carbon dioxide content of the permeate gas prior to the permeate gas entering the anode circuit.

14. The method as recited in claim 11 wherein the continuously monitoring includes measuring the at least one of the oxygen content and the carbon dioxide content of the permeate gas using a lambda probe.

15. The method as recited in claim 11 wherein the metering oxygen is performed by metering air.

16. The method as recited in claim 11 wherein the metering oxygen is performed by metering substantially pure oxygen.

17. The method as recited in claim 16 further comprising providing the oxygen from at least one of electrolytic generation and a pressurized cartridge.

18. The method as recited in claim 11 further comprising removing carbon dioxide from the anode circuit.

19. The method as recited in claim 11 wherein the fuel cell system is disposed in a motor vehicle.
